(19) United States
(12) Patent Application Publication
(10) Pub. No.: US 2026/0067247 A1
(43) Pub. Date: Mar. 5, 2026

(54) METHOD, APPARATUS, DEVICE AND STORAGE MEDIUM FOR MESSAGE INTERACTION

(71) Applicant: Beijing Zitiao Network Technology Co., Ltd., Beijing (CN)

(72) Inventors: Shiqi Wan, Beijing (CN); Jiayi Xu, Beijing (CN)

(21) Appl. No.: 19/320,008

(22) Filed: Sep. 5, 2025

(30) Foreign Application Priority Data
Sep. 5, 2024 (WO) PCT/CN2024/117283

(51) Int. Cl. H04L 51/42; H04L 51/216; H04L 51/224

(52) U.S. Cl. CPC H04L 51/42; H04L 51/216; H04L 51/224

(57) ABSTRACT

The embodiment of the disclosure relates to methods, apparatuses, devices and storage medium for message interaction. The proposed method includes: presenting an interactive content associated with a target user, the interactive content indicating a historical interactive event performed by the target user; receiving a predetermined operation on the interactive content, the predetermined operation indicating interactive feedback for the historical interactive event; and sending, in response to receiving the predetermined operation, a reminder message indicating the interactive feedback in a session with the target user. In this way, the embodiments of the present disclosure can improve the interaction efficiency between users.

### CROSS-REFERENCE

The present application claims priority to International Patent Application No. PCT/CN2024/117283, filed on Sep. 5, 2024 and entitled “METHOD, APPARATUS, DEVICE AND STORAGE MEDIUM FOR MESSAGE INTERACTION”, the entirety of which is incorporated herein by reference.

### FIELD

Example embodiments of the present disclosure generally relate to the field of computers, and in particular, to a method, an apparatus, a device, and a computer-readable storage medium for message interaction.

### BACKGROUND

In recent years, with the development of the Internet, more and more people perform network activities in a network platform. For example, a user interacts with other users via a network platform to meet social requirements. However, the existing network platform cannot meet the user's interaction requirement, resulting in a lower interaction efficiency between users.

### SUMMARY

In a first aspect of the present disclosure, there is provided a method for message interaction. The method comprises: presenting an interactive content associated with a target user, the interactive content indicating a historical interactive event performed by the target user; receiving a predetermined operation on the interactive content, the predetermined operation indicating interactive feedback for the historical interactive event; and sending, in response to receiving the predetermined operation, a reminder message indicating the interactive feedback in a session with the target user.

In a second aspect of the present disclosure, an apparatus for message interaction is provided. The apparatus comprises: a presenting module configured to present an interactive content associated with a target user, the interactive content indicating a historical interactive event executed by the target user; a receiving module configured to receive a predetermined operation on the interactive content, the predetermined operation indicating interactive feedback for the historical interactive event; and a sending module configured to send, in response to receiving the predetermined operation, a reminder message indicating the interactive feedback during a session with the target user.

In a third aspect of the present disclosure, an electronic device is provided. The electronic device comprises: at least one processing unit; and at least one memory coupled to the at least one processing unit and storing instructions for execution by the at least one processing unit. The instructions, when executed by the at least one processing unit, cause the electronic device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which some embodiments of the present disclosure can be implemented;

FIGS. 2A-2D illustrate example interfaces in accordance with some embodiments of the present disclosure;

FIG. 3 illustrates a flowchart of an example process of message interaction according to some embodiments of the present disclosure;

FIG. 4 illustrates a schematic structural block diagram of an example apparatus for message interaction according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiments described in same section/subsection and/or different sections/subsections.

In the description of the embodiments of the present disclosure, the terms “comprises” and the like should be understood as open terms that mean “include, but is not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may be further included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and related regulations. In the embodiments of the present disclosure, all data is collected, obtained, processed, forwarded, used, and the like, all of which are performed on the premise that the user knows and confirms. Accordingly, when implementing the embodiments of the present disclosure, the type, use scope, use scenario and the like of the data or information that may be involved should be notified to the user, and authorized by the user according to relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for performing a fulfillment contract), and processing only within a specified or agreed range. If the user rejects personal information other than necessary information required by the basic function, it does not affect the basic function for use of the user.

As briefly mentioned above, with the development of the Internet, more and more people perform network activities in a network platform. For example, a user interacts with other users via a network platform to meet social requirements. However, the existing network platform has a single interaction function, which cannot meet the interaction requirement of the user, resulting in low interaction efficiency between users.

The embodiment of the invention provides a scheme for message interaction. According to the scheme, interactive content associated with a target user may be presented. The interactive content indicates an interactive event of the target user. A predetermined operation on the interactive content may be received, wherein the predetermined operation indicates interactive feedback for the interactive event. Further, in response to receiving the predetermined operation, a reminder message indicating the interactive feedback may be sent in a session with the target user.

In this way, embodiments of the present disclosure can provide a user with interactive content capable of indicating related interactive events initiated by other users. Further, the embodiments of the present disclosure can accept the operation of the user, and correspondingly send the corresponding reminder message in the corresponding session. Therefore, the embodiment of the invention can promote message interaction among users and improve the interaction efficiency among users.

Various example implementations of this scheme are described in detail below in conjunction with the accompanying drawings.

### Example Environment

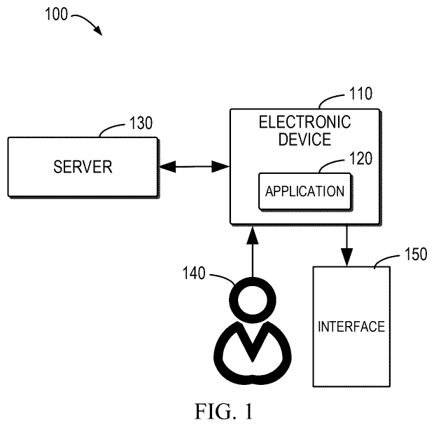

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop, a laptop, a notebook, a netbook, a tablet, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster or a distributed system composed of multiple physical servers, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for an application 120 supporting interface interaction in the electronic device 110.

A communication connection may be established between the server 130 and the electronic device 110. The communication connection may be established in a wired manner or a wireless manner. The communication connection may include, but is not limited to, a Bluetooth connection, a mobile network connection, a universal serial bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Example Interaction

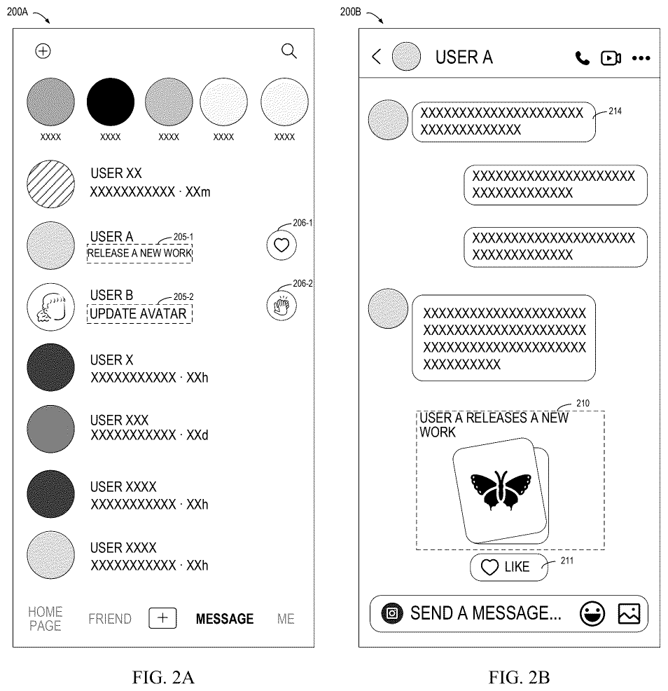

FIGS. 2A-2D illustrate example interfaces 200A-200D, in accordance with some embodiments of the present disclosure. The interfaces 200A-200D may be provided, for example, by the electronic device 110 shown in FIG. 1.

In some embodiments, the electronic device 110 may present interactive content associated with the target user.

In some embodiments, as shown in FIG. 2A, the electronic device 110 may present a message interface 200A of the current user. As an example, the electronic device 110 may present the message content received by the current user in the message list of the message interface 200A. For example, received messages from other users or friend requests from other users.

In some embodiments, with continued reference to FIG. 2A, the electronic device 110 may present interactive content (also referred to as first interactive content) associated with the target user in the message list of the message interface 200A. The first interactive content may indicate a historical interactive event performed by the target user.

In some embodiments, with continued reference to FIG. 2A, the electronic device 110 may present interactive content associated with the target user in response to the historical interactive information between the current user and the target user satisfying a predetermined condition. As an example, the historical interactive information between the current user and the target user may include an interval from the interaction time when the last interactive behavior between the current user and the target user occurs to the current time. For example, the interactive behavior may include sending a session message, commenting each other's works, giving the thumbs-up, and so on. As an example, the historical interactive information between the current user and the target user satisfies a predetermined condition, which may indicate that an interval from an interaction time when a last interactive behavior between the current user and the target user occurs to the current time exceeds a predetermined duration. As an example, the electronic device 110 may present the interactive content associated with the target user in the message list, in response to the interval from the interaction time when the last interactive behavior between the current user and the target user occurs to the current time exceeding a predetermined duration (for example, seven days).

In some embodiments, with continued reference to FIG. 2A, the electronic device 110 may cease presenting the interactive content in response to failing to receive a trigger for the interactive content within a predetermined time period. As an example, the trigger for the interactive content may include clicking on the interactive content, viewing the interactive content, or a trigger on a control associated with the interactive content (for example, clicking on the feedback control mentioned later). As an example, the predetermined time period is a duration in which the interactive content is presented. For example, the electronic device 110 may cease presenting the interactive content in the message list, in response to failing to receive the trigger for the interactive content within three days after the interactive content is presented. As an example, it is merely an example that the predetermined time period is within three days, and the present disclosure is not intended to limit the specific duration of the predetermined time period.

In some embodiments, with continued reference to FIG. 2A, the electronic device 110 may cease presenting the interactive content in the message list, in response to closing the interactive content (e.g., a trigger for a closing control associated with the interactive content).

In some embodiments, the interactive content may indicate historical interactive events performed by the target user. The interactive content may include a text content describing the historical interactive events and/or an image content associated with historical interactive events.

In some embodiments, the historical interactive event performed by the target user may include: a user interactive event for the current user by the target user. As an example, the user interactive event for the current user by the target user may include: like a work of the current user or an avatar, commenting a work of the current user, and/or accessing a personal page of the current user, etc.

As an example, the work of the current user may include the media content released or published by the current user in the application 120. As an example, the media content may include music content, video content, graphics and text content, and the like. As an example, the interactive content associated with the user interactive event for the current user may include an indication element associated with the user interactive event. For example, if the target user accesses the personal page of the current user, the interactive content may include an indication element capable of indicating the access behavior of the target user. As an example, the presentation style of the indication element capable of indicating the access behavior of the target user may be text content or image content (for example, a sticker type image).

In some embodiments, the historical interactive event performed by the target user may include a content update event associated with the target user. As an example, the content update event associated with the target user may include the target user releasing a new work (or referred to as media content) and/or the target user replacing the avatar in the application.

In some embodiments, the historical interactive event performed by the target user may include: a user interactive event for other users different from the current user by the current user. As an example, other users may be the users have an association relationship with the current user. As an example, other users may be friends of the current user in the application 120.

In some embodiments, determining the historical interactive event performed by the target user may include determining a set of candidate interactive events associated with the target user. As an example, the set of candidate interactive events may include a plurality of historical interactive events performed by the target user in a predetermined time period. It should be noted that the predetermined time period here is a time period before the interactive content is presented. For example, a set of interactive events may include a plurality of historical interactive events performed by a target user within a past week. As an example, the present disclosure is not intended to limit the specific duration of the predetermined time period.

In some embodiments, determining the historical interactive event performed by the target user may include: determining, by the electronic device 110, the historical interactive event from the set of candidate interactive events based on the priority information of the set of candidate interactive events.

In some embodiments, the priority information is determined based on time information of the corresponding candidate interactive event. As an example, the electronic device 110 may determine, based on a sequence of execution times of a set of candidate interactive events, a candidate interactive event that is performed earlier or later as the historical interactive event.

In some embodiments, the priority information is determined based on type information of the corresponding candidate interactive event. As an example, the type information of the candidate interactive event may include the first type and the second type. As an example, the first type of candidate interactive event may include a user interactive event for the current user by the target user (e.g., the target user accesses a personal page of the current user, and the like). As an example, the second type of candidate interactive event may include a content update event associated with the target user (e.g., the target user updates the avatar, releases a new work, and the like). As an example, the priority of the first type of candidate interactive event may be higher than the second type of candidate interactive event. As an example, the electronic device 110 may determine, based on a priority of a set of candidate interactive events, a candidate interactive event with a higher priority as a historical interactive event.

In some embodiments, the electronic device 110 may jointly determine the historical interactive event based on the time information and the type information of the set of candidate events. As an example, the electronic device 110 may determine a historical interactive event from a set of candidate events based on the type information. When there are multiple events determined from a set of candidate events based on the type information, the electronic device 110 may determine a historical interactive event from the multiple events based on the time information.

In some embodiments, with continued reference to FIG. 2A, the presentation position of the first interactive content in the message list is determined based on a time when a historical message was sent by the target user to the current user. As an example, the time when the user A sends the last message to the current user may be later than the time when the user B sends the last message to the current user. Thus, the presentation position of the first interactive content 205-1 associated with the user A in the message list may be more forward than that of the second interactive content 205-2 associated with the user B.

In some embodiments, with continued reference to FIG. 2A, the first interactive content may include a textual content describing the historical interactive events performed by the target user and/or an image content associated with the historical interactive events.

As an example, with continued reference to FIG. 2A, the historical interactive event associated with user A may include user A releasing a new work. The electronic device 110 may present the first interactive content 205-1 associated with the user A in the message list. As an example, the first interactive content 205-1 may include a text content (e.g., “release a new work”).

As an example, with continued reference to FIG. 2A, the historical interactive event associated with user B may include user B updating the avatar. The electronic device 110 may present the second interactive content 205-2 associated with the user B in the message list. As an example, the second interactive content 205-2 may include a textual content (e.g., “update avatar”).

In some embodiments, the electronic device 110 may present a feedback control associated with the interactive content. The feedback control may correspond to interactive feedback for historical interactive events. As an example, the feedback control may include a text content and/or an image content. As an example, the feedback control may include, for example, a text content such as “like” to indicate that the interactive feedback to the historical interactive event includes like for the historical interactive event. The following describes the feedback control including the image content as an example, and details are not described herein again.

In some embodiments, with continued reference to FIG. 2A, the electronic device 110 may present, in the message interface 200A, a first feedback control associated with the interactive content.

In some embodiments, different types of first feedback controls may have different display styles. As an example, different display styles may be reflected based on different colors, shapes, or sizes, etc.

As an example, with continued reference to FIG. 2A, the electronic device 110 may present the first feedback control 206-1 associated with the first interactive content 205-1 in the message interface 200A. As an example, the first feedback control 206-1 may correspond to a first type. Thus, the first feedback control 206-1 of the first type may indicate a first interactive feedback (e.g., like a new work of the user A) to the interactive event (e.g., user A releases the new work).

As an example, with continued reference to FIG. 2A, the electronic device 110 may present the first feedback control 206-2 associated with the second interactive content 205-2 in the message interface 200A. As an example, the first feedback control 206-2 may correspond to a second type. Thus, the first feedback control 206-2 of the second type may indicate a second interactive feedback (e.g., applause for User B's new avatar) to the interactive event (e.g., user B updates the avatar).

In some embodiments, the electronic device 110 may receive a predetermined operation on the interactive content. The predetermined operation indicates interactive feedback for the historical interactive event. Further, the electronic device 110 may send, in response to receiving the predetermined operation, a reminder message indicating the interactive feedback in a session with the target user. As an example, the interactive feedback of the predetermined operation on the interactive event may be determined by a feedback control associated with the predetermined operation.

In some embodiments, receiving, by the electronic device 110, the predetermined operation on the interactive content may include: receiving a trigger for the feedback control. As an example, the electronic device 110 may receive a click operation of the current user on the feedback control, which is treated as receiving a predetermined operation on the interactive content. As an example, the electronic device 110 may use the interactive feedback indicated by the triggered (e.g., clicked) feedback control as the interactive feedback corresponding to the predetermined operation.

In some embodiments, as shown in FIG. 2B, the electronic device 110 may present, in the session interface 200B with the target user, second interactive content associated with the target user. The electronic device 110 may present the second interactive content in a different manner than the session message.

In some embodiments, with continued reference to FIG. 2B, the electronic device 110 may present the second interactive content and the corresponding feedback control in the message display area of the session interface 200B. As an example, as shown in FIG. 2B, the electronic device 110 may present the second interactive content 210 associated with the user A and the corresponding second feedback control 211 at a bottom center position of the message display area in the session interface 200B with the user A. As an example, as shown in FIG. 2B, it is just an example that the electronic device 110 presents the second interactive content 210 at the bottom center position of the message display area of the session interface 200B. The present disclosure is not intended to limit the specific presentation position of the second interactive content in the message display area.

As an example, the second interactive content 210 may include, for example, a text content and an image content. As an example, the text content may include, for example, “User A releases a new work”. The image content may include, for example, an image content associated with the new work released by user A.

In some embodiments, with continued reference to FIG. 2B, the electronic device 110 may present a viewing interface of a target content associated with the historical interactive event in response to triggering the interactive content. Further, the electronic device 110 may present the complete content of the historical interactive event in the viewing interface. As an example, as shown in FIG. 2B, the image content displayed by the second interactive content 210 is part of image content in a new work released by the user A. The electronic device 110 may present, in response to receiving a trigger (for example, a click operation) of the current user on the second interactive content 210, a viewing interface (not shown in the figure) of the historical interactive event (for example, the user A releases a new work) associated with the second interactive content 210. Further, the electronic device 110 may present the complete content (for example, the complete image content, music content, and/or text content) of the work released by the user A in the viewing interface.

In some embodiments, with continued reference to FIG. 2B, the electronic device 110 may present a session interface 200B with the user A in response to receiving a predetermined operation of the current user. The electronic device 110 may present the session between the current user and user A in session interface 200B with user A. As an example, the electronic device 110 may present a session interface 200B with the user A in response to receiving a trigger of the current user on a control associated with the session interface in other interfaces.

In some embodiments, with continued reference to FIG. 2A, the electronic device 110 may present a session interface with the user A in response to receiving a trigger (e.g., a click operation) of the current user on a nickname, avatar, or first interactive content 205-1 associated with the user A.

In some embodiments, with continued reference to FIG. 2B, the electronic device 110 may present a second feedback control 211 associated with the second interactive content 210 in the session interface 200B with the user A. As an example, the interactive feedback indicated by the second feedback control 211 on an interactive event associated with the second interactive content 210 (e.g., the user A releases a new work) may include “like the new work of the user A”.

In some embodiments, with continued reference to FIG. 2B, the electronic device 110 may send, in response to receiving the trigger of the current user on the second feedback control 211, a reminder message associated with the second feedback control 211 to the user A in the session interface 200A with the user A. The reminder message may indicate the interactive feedback corresponding to the second feedback control 211.

In some embodiments, the reminder message may include a first content indicating the interactive feedback; and a second content indicating the historical interactive event.

In some embodiments, as shown in FIG. 2C, the electronic device 110 may present a reminder message 215-1 associated with the second feedback control 211 in the session interface 200C with the user A. For example, as shown in FIG. 2C, the reminder message 215-1 may include the first content indicating the interactive feedback and the second content indicating the historical interactive event. The first content may include, for example, a text content (e.g., “like a new work of user A”) and an image content indicated by a display style of the second feedback control 210. The second content may include, for example, an image content (e.g., an image associated with a new work of user A).

In some embodiments, with continued reference to FIG. 2A, the electronic device 110 may present a session interface with the user A in response to receiving a trigger (e.g., a click operation) of the current user on the first feedback control 206-1, and present a reminder message associated with the first feedback control 206-1 in the session interface.

In some embodiments, with continued reference to FIG. 2A, the electronic device 110 may present, in response to receiving a trigger (e.g., a click operation) of the current user on the first feedback control 206-2, a reminder message associated with the first feedback control 206-2 in a session interface with the user B associated with the first feedback control 206-2.

In some embodiments, as shown in FIG. 2D, the electronic device 110 may present a reminder message 215-2 associated with the first feedback control 206-2 in the session interface 200D with the user B. For example, as shown in FIG. 2D, the reminder message 215-2 may include a first content indicating the interactive feedback and second content indicating the historical interactive event.

As an example, the first content may include, for example, a text content (e.g., “applause for new avatar of user B”) and an image content indicated by the display style of the first feedback control 216-2. Additionally or alternatively, the second content may include the image content (e.g., a new avatar of user B).

Based on the above process, the embodiments of the present disclosure can provide the current user with interactive content associated with the historical interactive event executed by the target user after the current user does not perform the interaction behavior with the target user for more than the predetermined time.

Further, the embodiments of the present disclosure can provide the user with a feedback control associated with the interactive content, so that the user can quickly feedback based on the historical interactive event of the target user by the feedback control.

In this way, the embodiments of the present disclosure can provide the user with the interactive information and the feedback manner of other users, thereby improving the interaction efficiency between users.

### Example Processes

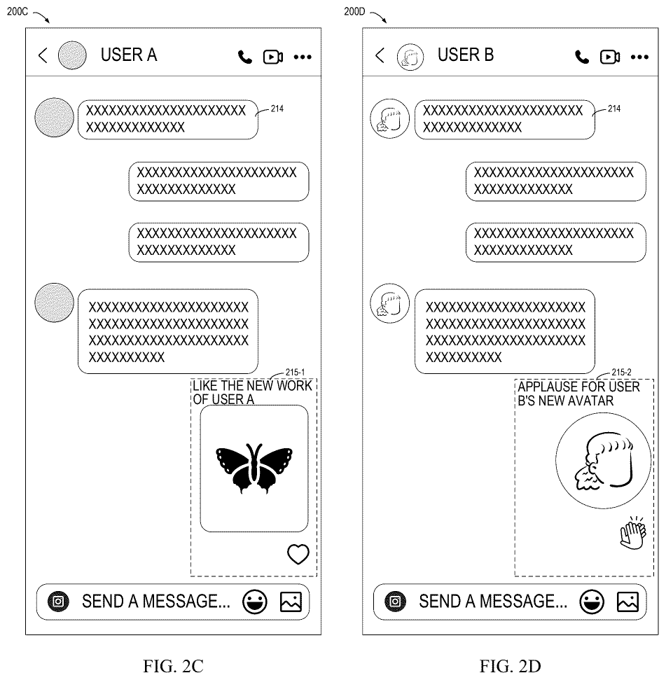

FIG. 3 illustrates a flowchart of an example process 300 of message interaction in accordance with some embodiments of the present disclosure. The process 300 may be implemented at the electronic device 110. The process 300 is described below with reference to FIG. 1.

As shown, at block 310, the electronic device 110 presents an interactive content associated with a target user, wherein the interactive content indicates a historical interactive event performed by the target user.

At block 320, the electronic device 110 receives a predetermined operation on the interactive content, wherein the predetermined operation indicates interactive feedback for the historical interactive event.

At block 330, the electronic device 110 sends, in response to receiving the predetermined operation, a reminder message indicating the interactive feedback in a session with the target user.

In some embodiments, receiving the predetermined operation on the interactive content comprises: presenting a feedback control associated with the interactive content, the feedback control corresponding to the interactive feedback for the historical interactive event; and receiving a trigger for the feedback control.

In some embodiments, presenting the interactive content associated with the target user comprises: presenting a first interactive content associated with the target user in a message list of a current user.

In some embodiments, a presentation position of the first interactive content in the message list is determined based on a time when a historical message was sent by the target user to the current user.

In some embodiments, presenting the interactive content associated with the target user comprises: presenting a second interactive content associated with the target user in a session interface with the target user, wherein the second interactive content is presented in a manner different than a session message.

In some embodiments, presenting the second interactive content associated with the target user in the session interface with the target user comprises: presenting the second interactive content and a corresponding feedback control in a message display area of the session interface.

In some embodiments, the interactive content comprises: a text content describing the historical interactive event; and/or an image content associated with the historical interactive event.

In some embodiments, the process 300 further comprises: in response to failing to receive a trigger for the interactive content within a predetermined time period, ceasing presenting the interactive content.

In some embodiments, presenting the interactive content associated with the target user comprises: in response to historical interactive information between the current user and the target user satisfying a predetermined condition, presenting the interactive content associated with the target user.

In some embodiments, the historical interactive event is determined through: determining a set of candidate interactive events associated with the target user; and determining the historical interactive event from the set of candidate interactive events based on priority information of the set of candidate interactive events.

In some embodiments, the priority information is determined based on time information and/or type information of a corresponding candidate interactive event.

In some embodiments, the historical interactive event performed by the target user comprises at least one of: a user interactive event for the current user by the target user; a content update event associated with the target user.

In some embodiments, the process 300 further comprises: in response to triggering the interactive content, presenting a viewing interface of a target content associated with the historical interactive event.

In some embodiments, the reminder message comprises: a first content indicating the interactive feedback; and a second content indicating the historical interactive event.

### Example Apparatus and Device

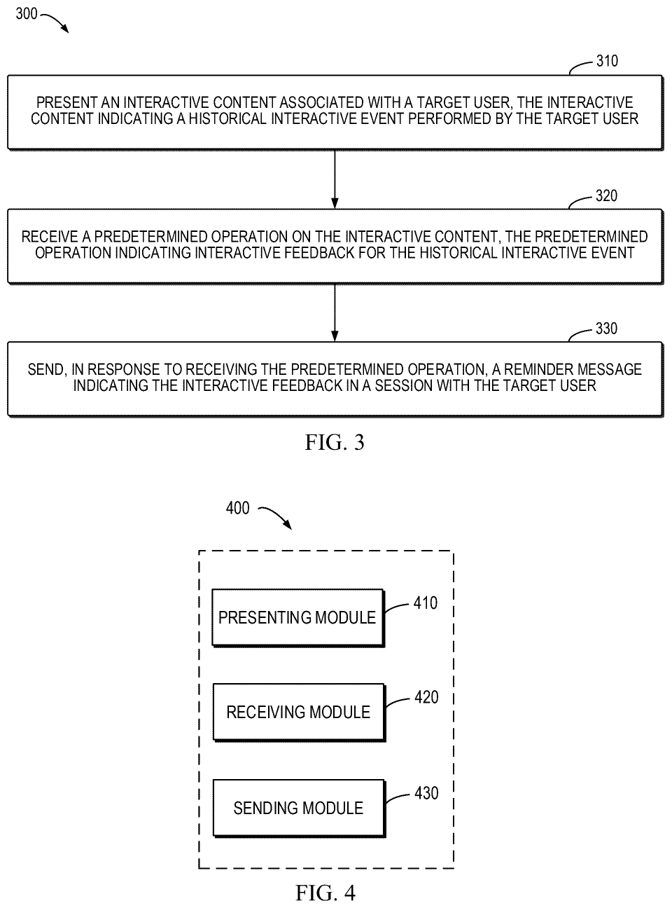

Embodiments of the present disclosure further provide a corresponding apparatus for implementing the above method or process. FIG. 4 shows a schematic structural block diagram of an example apparatus 400 for message interaction according to some embodiments of the present disclosure. The apparatus 400 may be implemented or included in an electronic device. The various modules/components in the apparatus 400 may be implemented by hardware, software, firmware, or any combination thereof.

As shown in FIG. 4, the apparatus 400 includes a presenting module 410 configured to present an interactive content associated with a target user, the interactive content indicating a historical interactive event executed by the target user; a receiving module 420 configured to receive a predetermined operation on the interactive content, the predetermined operation indicating interactive feedback for the historical interactive event; and a sending module 430 configured to send, in response to receiving the predetermined operation, a reminder message indicating the interactive feedback during a session with the target user.

In some embodiments, the receiving module 420 is further configured to present a feedback control associated with the interactive content, the feedback control corresponding to the interactive feedback for the historical interactive event; and receive a trigger for the feedback control.

In some embodiments, the presenting module 410 is further configured to present a first interactive content associated with the target user in a message list of a current user.

In some embodiments, a presentation position of the first interactive content in the message list is determined based on a time when a historical message was sent by the target user to the current user.

In some embodiments, the presenting module 410 is further configured to present a second interactive content associated with the target user in a session interface with the target user, wherein the second interactive content is presented in a manner different than a session message.

In some embodiments, the presenting module 410 is further configured to present the second interactive content and a corresponding feedback control in a message display area of the session interface.

In some embodiments, the interactive content comprises: a text content describing the historical interactive event; and/or an image content associated with the historical interactive event.

In some embodiments, the apparatus 400 further comprises a ceasing module configured to: in response to failing to receive a trigger for the interactive content within a predetermined time period, cease presenting the interactive content.

In some embodiments, the presenting module 410 is further configured to: in response to historical interactive information between the current user and the target user satisfying a predetermined condition, present the interactive content associated with the target user.

In some embodiments, the historical interactive event is determined through: determining a set of candidate interactive events associated with the target user; and determining the historical interactive event from the set of candidate interactive events based on priority information of the set of candidate interactive events.

In some embodiments, the priority information is determined based on time information and/or type information of a corresponding candidate interactive event.

In some embodiments, the historical interactive event performed by the target user comprises at least one of: a user interactive event for the current user by the target user; a content update event associated with the target user.

In some embodiments, the apparatus 400 further comprises a content module configured to: in response to triggering the interactive content, present a target interface associated with the historical interactive event, wherein the target interface presenting the complete content associated with the historical interactive event.

In some embodiments, the reminder message comprises: a first content indicating the interactive feedback; and a second content indicating the historical interactive event.

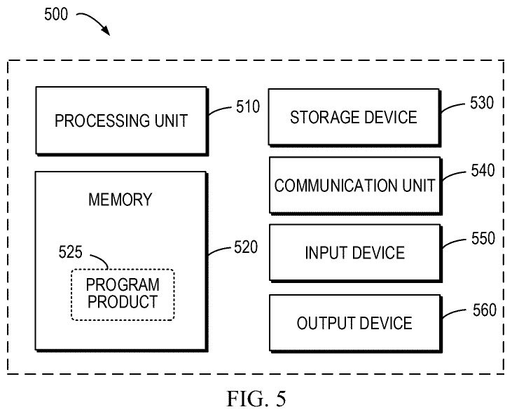

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be used for an electronic device.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from/to a removable, nonvolatile magnetic disk (e.g., a “floppy disk”) and an optical disk drive for reading or writing from/to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with other electronic devices through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, such as storage devices, display devices, and the like, communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, which is tangibly stored on a non-transitory computer-readable medium and includes computer-executable instructions that, when executed by a processor, implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks of the flowchart and/or block diagram.

The computer-readable program instructions may be loaded onto a computer, other programmable data processing apparatus, or other apparatus, such that a series of operational steps are performed on a computer, other programmable data processing apparatus, or other device to produce a computer-implemented process, such that the instructions executed on a computer, other programmable data processing apparatus, or other device implement the functions/acts specified in one or more blocks of the flowchart and/or block diagram.

The flowchart and block diagrams show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

I/We claim:

1. A method for message interaction, comprising:
presenting an interactive content associated with a target user, the interactive content indicating a historical interactive event performed by the target user;
receiving a predetermined operation on the interactive content, the predetermined operation indicating interactive feedback for the historical interactive event; and
sending, in response to receiving the predetermined operation, a reminder message indicating the interactive feedback in a session with the target user.

2. The method of claim 1, wherein receiving the predetermined operation on the interactive content comprises:
presenting a feedback control associated with the interactive content, the feedback control corresponding to the interactive feedback for the historical interactive event; and
receiving a trigger for the feedback control.

3. The method of claim 1, wherein presenting the interactive content associated with the target user comprises:
presenting a first interactive content associated with the target user in a message list of a current user.

4. The method of claim 3, wherein a presentation position of the first interactive content in the message list is determined based on a time when a historical message was sent by the target user to the current user.

5. The method of claim 1, wherein presenting the interactive content associated with the target user comprises:
presenting a second interactive content associated with the target user in a session interface with the target user, wherein the second interactive content is presented in a manner different than a session message.

6. The method of claim 5, wherein presenting the second interactive content associated with the target user in the session interface with the target user comprises:
presenting the second interactive content and a corresponding feedback control in a message display area of the session interface.

7. The method of claim 1, wherein the interactive content comprises:
a text content describing the historical interactive event; and/or
an image content associated with the historical interactive event.

8. The method of claim 1, further comprising:
in response to failing to receive a trigger for the interactive content within a predetermined time period, ceasing presenting the interactive content.

9. The method of claim 1, wherein presenting the interactive content associated with the target user comprises:
in response to historical interactive information between the current user and the target user satisfying a predetermined condition, presenting the interactive content associated with the target user.

10. The method of claim 1, wherein the historical interactive event is determined through:
determining a set of candidate interactive events associated with the target user; and
determining the historical interactive event from the set of candidate interactive events based on priority information of the set of candidate interactive events.

11. The method of claim 10, wherein the priority information is determined based on time information and/or type information of a corresponding candidate interactive event.

12. The method of claim 1, wherein the historical interactive event performed by the target user comprises at least one of:
a user interactive event for the current user by the target user;
a content update event associated with the target user.

13. The method of claim 1, further comprising:
in response to triggering the interactive content, presenting a viewing interface of a target content associated with the historical interactive event.

14. The method of claim 1, wherein the reminder message comprises:
a first content indicating the interactive feedback; and
a second content indicating the historical interactive event.

15. An electronic device comprising:
at least one processing unit; and
at least one memory coupled to the at least one processing unit and storing instructions for execution by the at least one processing unit, the instructions, when executed by the at least one processing unit, causing the electronic device to perform acts comprising:
presenting an interactive content associated with a target user, the interactive content indicating a historical interactive event performed by the target user;
receiving a predetermined operation on the interactive content, the predetermined operation indicating interactive feedback for the historical interactive event; and
sending, in response to receiving the predetermined operation, a reminder message indicating the interactive feedback in a session with the target user.

16. The electronic device of claim 15, wherein receiving the predetermined operation on the interactive content comprises:
presenting a feedback control associated with the interactive content, the feedback control corresponding to the interactive feedback for the historical interactive event; and
receiving a trigger for the feedback control.

17. The electronic device of claim 15, wherein presenting the interactive content associated with the target user comprises:
presenting a first interactive content associated with the target user in a message list of a current user.

18. The electronic device of claim 17, wherein a presentation position of the first interactive content in the message list is determined based on a time when a historical message was sent by the target user to the current user.

19. The electronic device of claim 15, wherein presenting the interactive content associated with the target user comprises:
presenting a second interactive content associated with the target user in a session interface with the target user, wherein the second interactive content is presented in a manner different than a session message.

20. A non-transitory computer-readable storage medium having stored thereon a computer program that, when executed by a processor, implements a method comprising:
presenting an interactive content associated with a target user, the interactive content indicating a historical interactive event performed by the target user;
receiving a predetermined operation on the interactive content, the predetermined operation indicating interactive feedback for the historical interactive event; and
sending, in response to receiving the predetermined operation, a reminder message indicating the interactive feedback in a session with the target user.
